(19) United States
(12) Patent Application Publication
(10) Pub. No.: US 2026/0024472 A1
(43) Pub. Date: Jan. 22, 2026

(54) TRIM COMPONENT COMPRISING A DECORATIVE AREA WITH A BACKLIT CONTOUR

(71) Applicant: FLEX-N-GATE FRANCE, AUDINCOURT (FR)

(72) Inventors: David LAURENÇOT, RAYNANS (FR); Jérôme VERBRUGGHE, ELOIE (FR); Thierry RECEVEUR, VILLARS LES BLAMONT (FR)

(21) Appl. No.: 19/274,956

(22) Filed: Jul. 21, 2025

(30) Foreign Application Priority Data
Jul. 22, 2024 (FR) 24 08050

(51) Int. Cl. G09F 21/04

(52) U.S. Cl. CPC G09F 21/04

(57) ABSTRACT

The component (1) comprises:
a decorative area (2) extending between an internal face and an external face (5), substantially translucent;
a peripheral area (4) surrounding a part of the decorative area (2), and extending between an internal face and an external face (5) and being opaque;
an opaque coating layer (6) extending over a part of the external face (5),
at least one backlit area (8) formed by the part of the decorative area extending between the opaque coating layer (6) and the peripheral area (4), said backlit area (8) extending between a first edge (7), formed by an edge of the opaque coating layer, and a second edge (9), formed by an edge of the peripheral area (4), said backlit area (8) allowing light to pass from the internal face to the external face (5).

The present invention relates to a vehicle trim component comprising:
at least one decorative area extending between an internal face and an external face, said decorative area being substantially translucent so as to allow light to pass from the internal face to the external face;
at least one peripheral area surrounding at least one part of the decorative area, said peripheral area extending between an internal face and an external face and being opaque so as to prevent the passage of light from the internal face to the external face;
an opaque coating layer extending over a part of the external face of the decorative area, so as to prevent the passage of light through the part of the decorative area extending facing the opaque coating layer,
at least one backlit area formed by the part of the decorative area extending between the opaque coating layer and the peripheral area, said backlit area extending between a first edge, formed by an edge of the opaque coating layer, and a second edge, formed by an edge of the peripheral area, said backlit area allowing light to pass from the internal face to the external face.

The invention relates, for example, to a trim component intended to form a vehicle body component.

It is known to equip such a trim component with a decorative area presenting a particular appearance and/or shape relative to the rest of the trim component in order to give a particular appearance to this trim component. Thus, it may be provided to integrate a medallion or other into the trim component, for example, to show a symbol representative of the vehicle model or a logo of the car manufacturer.

It may be provided to illuminate the decorative area in order to further enhance the appearance of the trim component. Such lighting is more particularly backlighting, in other words, the light illuminating the decorative area is emitted from the side of an internal surface of the trim component and passes through the decorative area to be visible from the side of the external surface of the trim component.

However, the integration of a medallion and backlighting into a trim component is a complex operation, and the appearance of the obtained trim component can still be improved.

One of the aims of the invention is therefore to propose a trim component comprising a decorative area, a part of which is backlit in a simple way and presenting a satisfactory appearance.

To this end, the invention has as its object a vehicle trim component comprising:
at least one decorative area extending between an internal face and an external face, said decorative area being substantially translucent so as to allow light to pass from the internal face to the external face;
at least one peripheral area surrounding at least one part of the decorative area, said peripheral area extending between an internal face and an external face and being opaque so as to prevent the passage of light from the internal face to the external face;
an opaque coating layer extending over a part of the external face of the decorative area, so as to prevent the passage of light through the part of the decorative area extending facing the opaque coating layer,
at least one backlit area formed by the part of the decorative area extending between the opaque coating layer and the peripheral area, said backlit area extending between a first edge, formed by an edge of the opaque coating layer, and a second edge, formed by an edge of the peripheral area, said backlit area allowing light to pass from the internal face to the external face.

The production of a trim component comprising a decorative area, at least one part of the perimeter of which is backlit, allows for a clear contrast and the enhancement of the shape represented in the decorative area to be obtained.

According to other advantageous aspects of the invention, the trim component comprises one or more of the following features, taken individually or in all technically possible combinations:
the backlit area and the peripheral area are from material comprising a translucent material to form the decorative area and an opaque material forming the peripheral area;
the opaque coating layer is produced in a metallic material;
the opaque coating layer is produced in paint or in ink.
the peripheral area completely surrounds the decorative area;
the backlit area completely surrounds the part of the decorative area covered with the opaque coating;
a light source is placed on the side of the internal face of the decorative area, said light source producing light visible from the external face of the backlit area;
the trim component comprises at least one internal backlit area, completely surrounded by the opaque coating layer, defined by any part of the decorative area the external face of which is devoid of opaque coating.

According to another aspect, the invention also relates to a method for the production of a trim component such as described above, the method containing the following steps:
production of a decorative area in a translucent material;
production of a peripheral area in an opaque material around at least one part of the decorative area;
application of an opaque coating layer on the external face of at least one part of the decorative area;
definition of a backlit area extending between a first edge, formed by an edge of the opaque coating layer, and a second edge, formed by an edge of the peripheral area, said backlit area allowing light to pass from the internal face to the external face.

According to other advantageous aspects of the invention, the method for the production of the trim component comprises one or more of the following features, taken individually or in all technically possible combinations:
an opaque coating layer is applied by physical vapor deposition of a metallic material;
the opaque coating layer is applied by one of the process in the group comprising: paint coating, screen printing, pad printing, and inkjet printing;
the opaque coating layer covers the entire external face of the decorative area, a part of which is removed to form the backlit area;
the decorative area and the peripheral area are produced in one piece by bi-material injection;
the method comprises an additional step of ablating a part of the opaque coating layer to produce at least one internal backlit area completely surrounded by the opaque coating layer.

The invention will become clearer upon reading the following description, given solely by way of non-limiting example, and made with reference to the drawings in which:

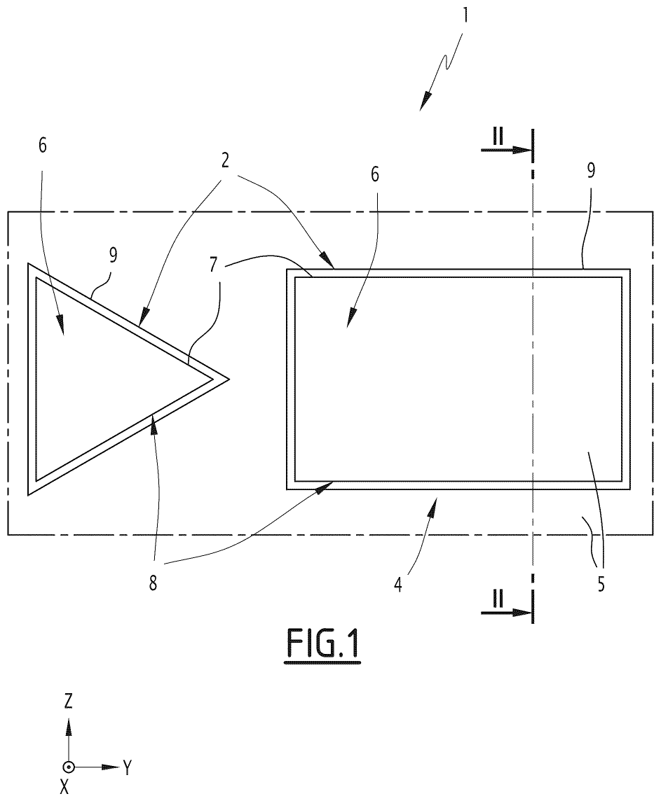

FIG. 1 is a front view of a trim component according to the invention,

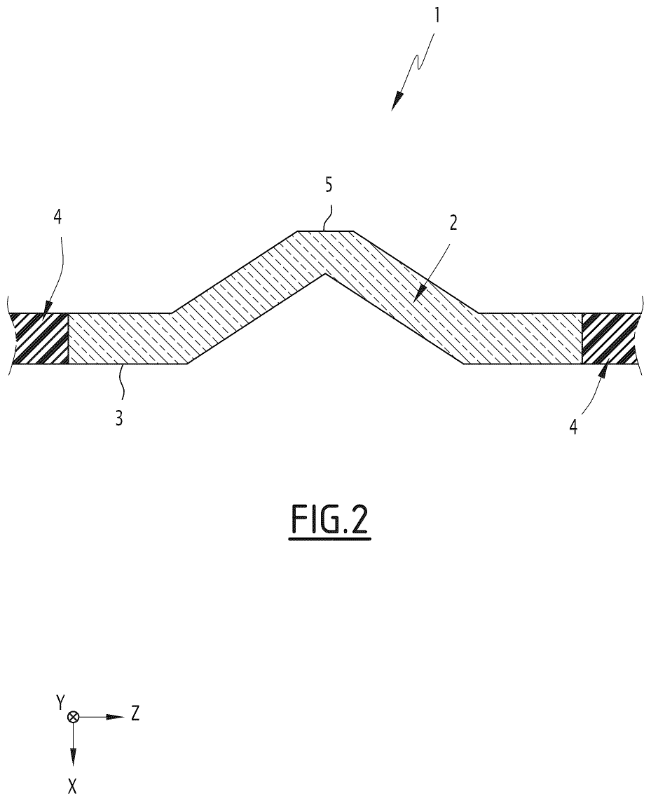

FIG. 2 is a schematic sectional view of a part of the trim component, according to the axis II-II, of FIG. 1,

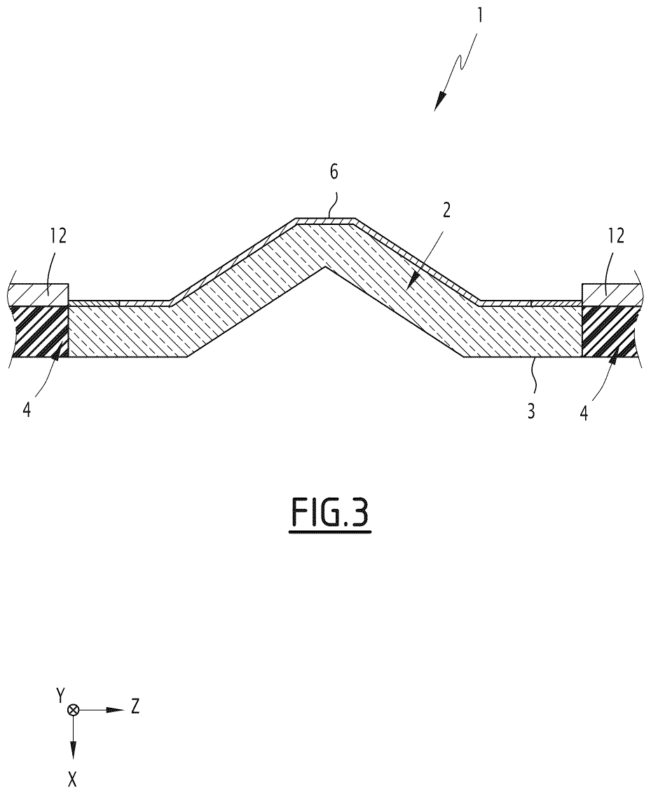

FIG. 3 is a schematic sectional view of the part of the trim component of FIG. 2 during a step of producing the trim component,

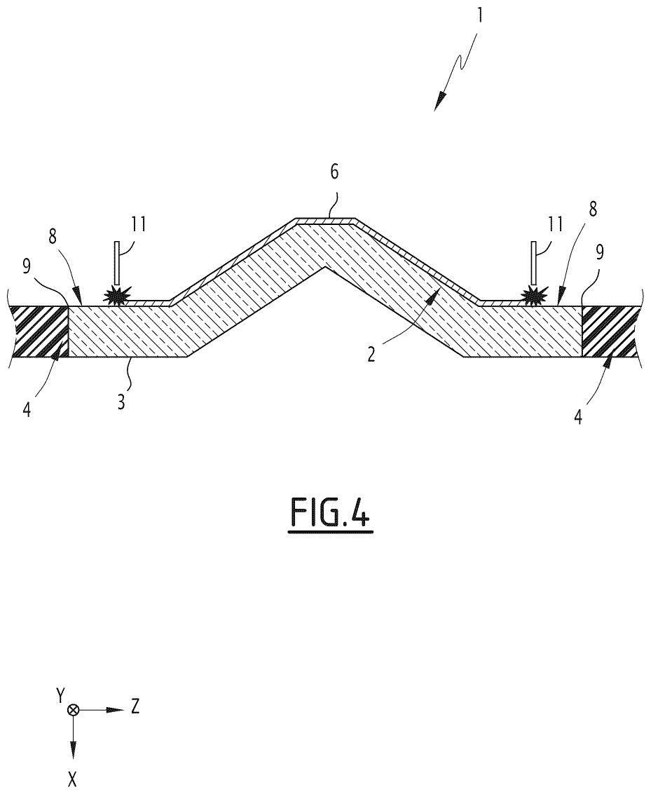

FIG. 4 is a schematic sectional view of the part of the trim component of FIG. 2, during another step of producing the trim component,

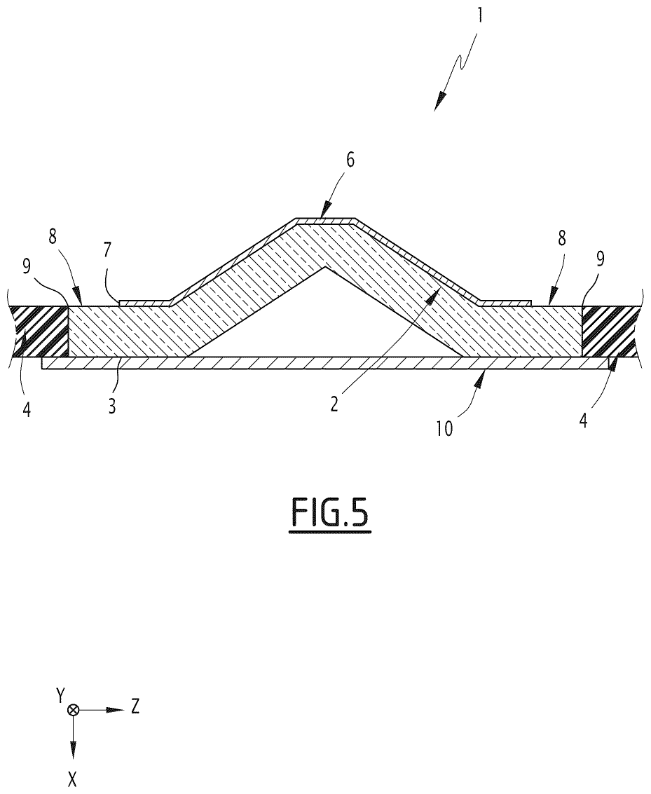

FIG. 5 is a schematic sectional view of the trim component of FIG. 2, after the last step of the method,

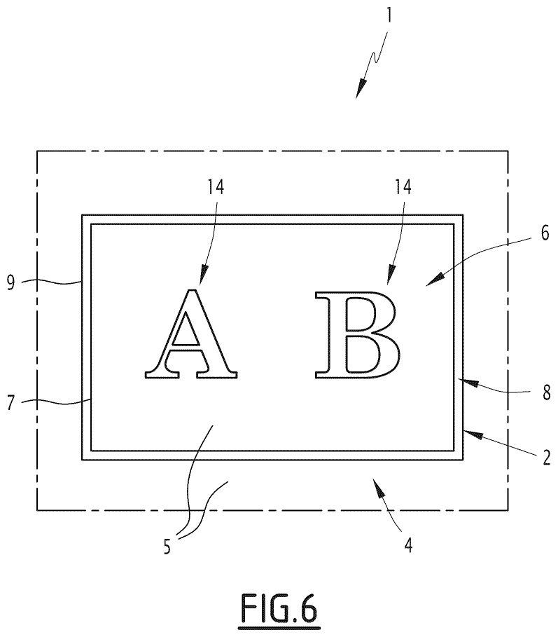

FIG. 6 is a front view of a trim component according to a complementary embodiment.

Referring to FIG. 1, a vehicle trim component 1 is described, extending between an internal face 3, intended to be turned toward the vehicle on which the trim component 1 is installed, and an external face 5, visible in FIG. 1, opposite the internal face 3 and intended to be turned toward the outside of the vehicle. The thickness of the trim component 1 is defined as being the distance between the internal face 3 and the external face 5 and extends according to a longitudinal direction X, corresponding for example to the front-rear direction of the vehicle. The internal face 3 and the external face 5 generally extend according to a transverse direction Y, corresponding for example to the width of the vehicle, and an elevation direction Z, corresponding for example to the height of the vehicle.

The trim component 1 is, for example, a vehicle body part, such as a bumper skin or other.

The trim component 1 comprises at least one decorative area 2, forming for example, a medallion, as well as at least one peripheral area 4 that surrounds at least a part of the decorative area 2. The external face 5 of the decorative area 2, located on the external side of the trim component 1, is partially covered with a substantially opaque coating layer 6. As will be described in more detail later, between the opaque coating layer 6 and the peripheral area 4, the trim component 1 comprises a so-called backlit area 8.

By “opaque,” it is meant that the coating layer does not allow light to pass in the visible domain from its internal face to its external face. In other words, if the coating layer is illuminated from the side of its internal face, the light does not pass through the coating layer and is not visible from the side of its external face.

The peripheral area 4 is opaque, in other words, it does not allow light to pass, at least from the internal face 3 toward the external face 5. To do this, the peripheral area 4 is produced in an opaque material preventing light from passing through the thickness of the peripheral area 4.

The decorative area 2 is substantially translucent, at least from the internal face 3 toward the external face 5. The decorative area 2 can present any desired shape, for example, any geometric shape, a logo shape, an alphanumeric symbol, or other. As visible in FIG. 2, the decorative area 2 can extend at least partially in relief toward the outside of the external face 5 of the peripheral area. Alternatively, the decorative area 2 can extend in recess toward the inside of the external face 5 of the peripheral area 4 or be flush with the external face 5 of the peripheral area 4 so that the external face 5 of the trim component is substantially flat or domed.

By “translucent,” it is meant that the decorative area allows at least one part of the light in the visible domain to pass from its internal face 3 toward its external face 5, in particular, it is possible that it allows all visible light to pass. In other words, light emitted from the side of the internal face 3 of the decorative area 2 can pass through the thickness of the decorative area 2 to be visible on the external face 5 of it.

According to one embodiment, the trim component 1 comprises at least two distinct decorative areas 2 spaced apart from each other as represented in FIG. 1, in which two decorative areas 2A, 2B of different shapes are represented. The different decorative areas can be of any shape and size and different from each other.

As previously indicated, the peripheral area 4 extends around at least one part of the or each decorative area 2. In other words, the peripheral area 4 is adjacent to at least one part of the decorative area 2 according to the transverse direction Y and/or according to the elevation direction Z. According to one embodiment, the peripheral area 4 extends around the entire contour of the decorative area 2. According to this embodiment, the peripheral area 4 completely surrounds the decorative area 2 according to the transverse and elevation directions, as represented in FIG. 1. When the trim component 1 comprises several decorative areas, the peripheral area 4 extends between the decorative areas and joins them together. According to one embodiment, all the decorative areas are entirely surrounded by the peripheral area.

According to one embodiment, the peripheral and the decorative areas 4 and 2 are made of material, in other words, the peripheral area and the decorative area(s) 2 are produced in one piece, for example, by bi-injection, as will be described in more detail later. The peripheral and decorative areas are, for example, produced in polycarbonate, with the polycarbonate being opaque to produce the peripheral area and being translucent to produce the decorative area(s).

A part of the external face of the decorative area 2E is covered with an opaque coating layer 6, represented in FIG. 5, this opaque coating layer 6 creates an extra thickness E on a part of the external face 5 of the decorative area 2, the thickness E being, for example, constant according to the longitudinal direction. This opaque coating layer 6 of the external face 5 of the decorative area 2 can be metallic, for example, made of an aluminum or steel alloy. The portion of the decorative area 2 covered with an opaque coating layer 6 is referred to as the “opaque area.”

Advantageously, the choice of metallic materials for the opaque coating 6 of the decorative area 2 allows to ensure a chromed or shiny visual effect, for example, in the opaque area. In addition, since the coating layer is opaque, it blocks the passage of light beyond the external face of the decorative area 2 in the opaque area. In other words, light emitted from the side of the internal face of the opaque area is not visible from the outside of the trim component at the level of the coating layer 6.

In one embodiment in which several distinct decorative areas exist, each of these areas is partially covered with an opaque coating layer 6 such as previously defined. Preferably, the extra thickness E of the different decorative areas 2A, 2B covered with an opaque coating layer 6 are equal; alternatively, they are different.

The opaque coating layer 6 does not entirely cover the external face 5 of the or each decorative area 2 and leaves at least one part of the contour of the or each decorative area 2 bare, in other words, not covered by the opaque coating layer 6. This uncovered part forms the backlit area 8 of the trim component 1. In other words, from the outside of the trim component, the external faces of the peripheral area, the backlit area(s), and the coating layer(s) are visible, while light emitted from the side of the internal face is visible only from the side of the external face 5 in the backlit area 8. The external face 5 of the part of the or each decorative area covered by an opaque coating layer 6 is, however, invisible from the outside of the trim component.

Thus, as represented in FIG. 5, the backlit area 8 is a part of the decorative area 2, which is not covered by the previously described opaque coating layer 6 and extends in the transverse and/or elevation direction between a first edge 7 formed by the edge of the opaque coating layer 6 and a second edge 9 formed by the peripheral area 4. This backlit area 8 presents a width L, defined as the distance between the first edge 7 and the second edge 9, as represented in FIG. 1.

For example, this width L can be substantially constant over the entire perimeter of this backlit area 8.

In the particular embodiment represented in FIG. 1, the backlit area 8 completely surrounds the opaque area according to the transverse Y and elevation Z directions.

In any embodiment comprising several decorative areas, each decorative area 2 defines a backlit area 8 such as previously described.

The backlit area 8 being translucent, it can, according to a particular embodiment, be illuminated, thanks to at least one light source 10 placed on the side of the internal face of the trim component, so that this area visually contrasts with the peripheral area 4 and with the coated decorative area 2. The light source 10 can be of any shape, such as surface type, point type, for example. The light source 10 is, for example, placed facing the or each decorative area, on the side of the internal face of it/them.

According to one embodiment, the trim component comprises a single light source 10 illuminating the different backlit areas 8, for example, a panel of light-emitting diodes. Alternatively, the trim component comprises several light sources 10, each illuminating one or more backlit areas 8. It is also possible that only a part of the backlit areas 8 is actually illuminated by a light source 10.

The invention therefore allows to produce a decorative area 2, possibly in relief, with a chromed effect. This chromed effect can be enhanced by the light coming from the backlit area 8, notably by means of a high luminous power thanks to the use of a light source 10 adapted to the need and placed behind the decorative area 2.

A production method allowing the production of the previously described trim component 1 will now be detailed.

A first step of the production method of the trim component 1, the result of which is visible in FIG. 2, consists of the production of a decorative area 2 according to the invention.

A second step of the production method of the trim component 1 consists of the production of the peripheral area 4 according to the invention.

The first step and the second step can be done by bi-injection of an opaque material to produce the peripheral area 4 and a translucent material to produce the decorative area 2. This improves the visual effect of the trim component 1 by the continuity between the two areas.

The shape of the two areas is free, in particular, the decorative area 2 can present reliefs as illustrated in FIG. 2.

In one particular embodiment in which the trim component 1 contains several decorative areas 2A, 2B, the first step then consists of the production of all these areas by bi-injection.

A third step of the production method of the trim component 1 consists of the production of the opaque coating layer 6 on the external face 5 of the decorative area 2.

In particular, this step can be carried out by physical vapor deposition of a metallic material.

FIG. 3 shows the piece represented at the third step of the method.

As represented in FIG. 3, during the deposition of the opaque coating 6, the external face 5 of its peripheral area 4 can be provided with a mask 12 allowing to prevent the deposition of the opaque coating layer 6 on the peripheral area 4. In this case, the mask 12 is removed at the end of this third step, in order to continue the method.

In one embodiment in which several decorative areas 2 are present, a possible mask 12 can be composed of several openings, or the operation can involve the use of several masks 12. In all cases, if one or more masks 12 are used, they are all removed at the end of the operation. Advantageously, the operation of depositing the opaque coating layer 6 is done in one pass for all the areas to be coated; alternatively, it can be done sequentially in several passes.

In one particular embodiment, the opaque coating layer 6 extends, at the end of the third step, over the entire external face 5 of the decorative area 2, including on the area intended to form a backlit area 8. In this case, a fourth step consists of ablating a part of the opaque coating layer 6, in order to produce the backlit area 8. This ablation can, for example, be carried out by laser. Such an ablation by laser allows for precise definition of the shape of the backlit area. This fourth operation can concern several decorative areas if the considered embodiment has several; it can be a part or all of these areas.

Alternatively, the opaque coating layer 6 does not extend over the backlit area 8, it is not then necessary to use ablation of a part of the opaque coating layer 6. This embodiment can be obtained by using the masks 12 that extend over the entire external face 5 of the backlit area 8, in other words, which extend up to the first edge 7, in addition to covering the peripheral area. In the case where the embodiment involves the existence of several decorative areas 2, it may be necessary to perform ablation by laser on a part, all, or none of the decorative areas 2.

For example, a material is considered “opaque” if its transmittance in the visible domain is less than or equal to 40%, preferably less than or equal to 20%.

Advantageously, the external face 5 of the peripheral area 4 and the external face 5 of the decorative area 2 are directed in the same direction, in other words, together they define at least one part of the external surface of the trim component 1. Similarly, the internal faces 3 of the decorative area 2 and the peripheral area 4 are directed in the same direction, meaning together they define at least one part of the internal surface of the trim component 1.

In a variant of the trim component 1, the opaque coating layer 6 is produced in paint or in ink.

The opaque coating layer 6 is for example applied by paint coating. In a variant, the opaque coating layer 6 is applied by screen printing, or by pad printing, or by inkjet printing. The use of a layer of paint or ink is advantageous because it allows a greater variety of colors than the application of metallic materials.

Advantageously, the opaque coating layer 6 is covered with a protective layer, for example, transparent. The protective layer then covers the decorative area 2, of which, the opaque coating layer 6, and preferably at least one part of the peripheral area 4.

In one alternative represented in FIG. 6, the trim component 1 further comprises at least one internal backlit area 14 completely surrounded by the opaque coating layer 6. The internal backlit area 14 is defined by any part of the decorative area 2 the external face 5 of which is devoid of the opaque coating layer 6 while being completely surrounded by the opaque coating layer 6.

Such as represented in FIG. 6, the trim component 1 comprises two internal backlit areas 14, each forming a letter-shaped pattern. It is understood that this representation is given only as an example and that the trim component 1 may comprise fewer or more than two internal backlit areas 14.

In a variant of the method for the production of the trim component 1, the third step of the process, the step of application of the opaque coating layer 6, is carried out by one of the method of the group comprising: paint coating, screen printing, pad printing, and inkjet printing.

A fifth optional step of the method for the production of the trim component 1 consists of ablating a part of the opaque coating layer 6, in order to produce the internal backlit area(s) 14 within the opaque coating layer 6. For example, this step is carried out by ablation by laser.

1. A vehicle trim component comprising:
at least one decorative area extending between an internal face and an external face, said decorative area being substantially translucent so as to allow light to pass from the internal face to the external face
at least one peripheral area surrounding at least one part of the decorative area, said peripheral area extending between an internal face and an external face and being opaque so as to prevent the passage of light from the internal face to the external face
an opaque coating layer extending over a part of the external face of the decorative area, so as to prevent the passage of light through the part of the decorative area extending opposite the opaque coating layer,
at least one backlit area formed by the part of the decorative area extending between the opaque coating layer and the peripheral area, said backlit area extending between a first edge, formed by an edge of the opaque coating layer, and a second edge, formed by an edge of the peripheral area, said backlit area allowing light to pass from the internal face to the external face.

2. The trim component according to claim 1, wherein the backlit area and the peripheral area are from material comprising a translucent material to form the decorative area and an opaque material forming the peripheral area.

3. The trim component according to claim 1, wherein the opaque coating layer is produced in a metallic material.

4. The trim component according to claim 1, wherein the opaque coating layer is produced in paint or in ink.

5. The trim component according to claim 1, wherein the peripheral area completely surrounds the decorative area.

6. The trim component according to claim 1, wherein the backlit area completely surrounds the part of the decorative area covered with the opaque coating.

7. The trim component according to claim 1, wherein a light source is placed on the side of the internal face of the decorative area, said light source producing light visible from the external face of the backlit area.

8. The trim component according to claim 1, comprising at least one internal backlit area, completely surrounded by the opaque coating layer, defined by any part of the decorative area the external face of which is devoid of opaque coating.

9. A method for the production of a trim component according to claim 1, comprising the following steps:
Production of a decorative area in a translucent material
Production of a peripheral area in an opaque material around at least one part of the decorative area
Application of an opaque coating layer on the external face of at least one part of the decorative area
Definition of a backlit area extending between a first edge, formed by an edge of the opaque coating layer, and a second edge, formed by an edge of the peripheral area, said backlit area allowing light to pass from the internal face to the external face.

10. The method for the production of a trim component according to claim 9, wherein an opaque coating layer is applied by physical vapor deposition of a metallic material.

11. The method for the production of a trim component according to claim 9, wherein the opaque coating layer is applied by one of the process in the group comprising: paint coating, screen printing, pad printing, and inkjet printing.

12. The method for the production of a trim component according to claim 9, wherein the opaque coating layer covers the entire external face of the decorative area, a part of which is removed to form the backlit area.

13. The method for the production of a trim component according to claim 9, wherein the decorative area and the peripheral area are produced in one piece by bi-material injection.

14. The method for the production of a trim component according to claim 9, comprising an additional step of ablating a part of the opaque coating layer to create at least one internal backlit area completely surrounded by the opaque coating layer.
